(19) United States
(12) Patent Application Publication
(10) Pub. No.: US 2016/0042478 A1
(43) Pub. Date: Feb. 11, 2016

(54) Methods and Systems for Verifying Images Associated With Offered Properties

(71) Applicant: MASTERCARD INTERNATIONAL INCORPORATED, Purchase, NY (US)

(72) Inventor: Justin X. Howe, San Fransicso, CA (US)

(21) Appl. No.: 14/451,542

(22) Filed: Aug. 5, 2014

(51) Int. Cl. G06Q 50/16; G06F 17/30; G06Q 30/06

(52) U.S. Cl. CPC G06Q 50/16; G06Q 30/0625; G06F 17/30268

(57) ABSTRACT

Methods and systems are provided for verifying images associated with properties offered for sale, lease, or rent. One exemplary method includes receiving, at a computing device, at least one image associated with a real property and searching, in a listing database, for the at least one image. The at least one image depicts at least a portion of the real property, and the listing database includes a plurality of known images, each associated with real property. The method also includes flagging, at the computing device, the at least one image as a preexisting image when the at least one image matches one of the plurality of known images in the listing database.

### FIELD

The present disclosure generally relates to methods and systems for verifying images associated with properties offered for sale, lease, or rent.

### BACKGROUND

This section provides background information related to the present disclosure which is not necessarily prior art.

Properties are often advertised and/or offered for sale, lease, or rent through different mediums. Images of the properties are typically provided in connection with such offers, especially for offers provided through one or more websites. These images permit consumers to view the properties before buying, leasing, or renting them. For example, property listing agency websites are known to offer properties for rent, and often include images of such properties, including their various rooms, and the amenities associated therewith, to permit potential consumer to compare different properties before renting.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in verifying images associated with properties offered for sale, lease, or rent;

FIG. 2 is a block diagram of a computing device, that may be used in the exemplary system of FIG. 1; and

FIG. 3 is an exemplary method for use in verifying images associated with properties offered for sale, lease, or rent.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Consumers often purchase, lease, or rent properties from merchants through websites or other medium (e.g., by email, by mail, etc.) where the consumer is not present at the merchant, or able to inspect the properties before completing a transaction. To help facilitate the transactions, images (e.g., photos) of the properties may be provided to the consumers for review before buying, leasing, or renting (e.g., through the websites, via email, via mail, etc.). The consumers then transact for the properties based, at least in part, on the images without ever actually seeing the properties in person. Methods and systems described herein verify the images of the properties presented by the merchants, before the consumers transacts for them, to help confirm to the consumers that the images are actually associated with the properties being offered by the merchants. In so doing, the methods and systems may reduce the potential for consumers to base decisions to transact for the properties on false and/or misleading images of the properties.

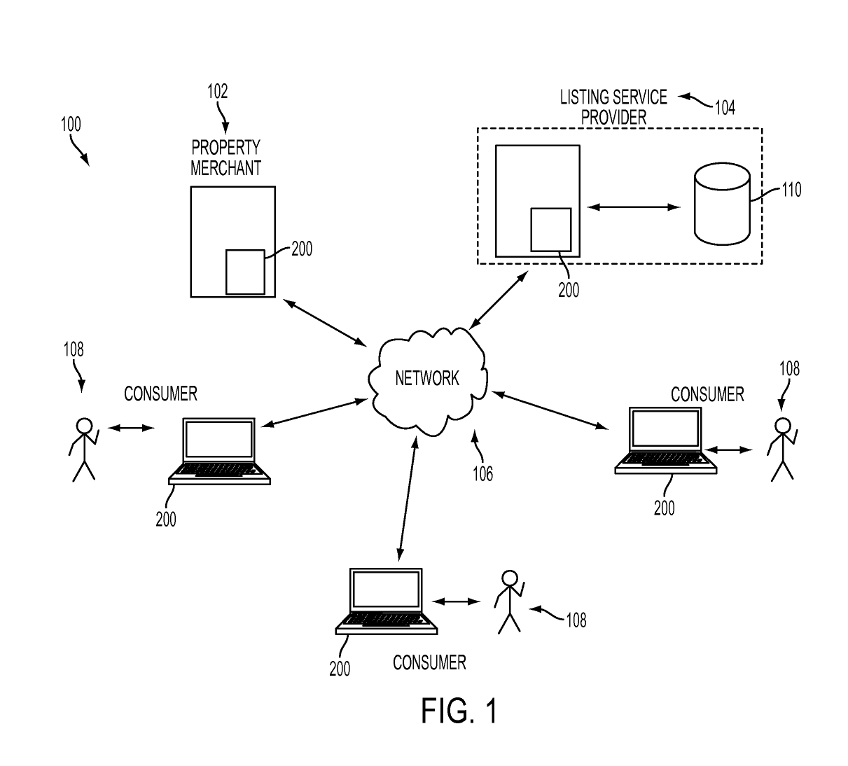

With reference now to the drawings, FIG. 1 illustrates an exemplary system 100, in which one or more aspects of the present disclosure may be implemented. Although components of the system 100 are presented in one arrangement, it should be appreciated that other exemplary embodiments may include the same or different components arranged otherwise, for example, depending on associations and/or identities of consumers, merchants, listing service providers, etc.

The illustrated system 100 generally includes a property merchant 102 and a listing service provider 104, each coupled to network 106. The network 106 may include, without limitation, a wired and/or wireless network, one or more local area network (LAN), wide area network (WAN) (e.g., the Internet, etc.), mobile network, other network as described herein, and/or other suitable public and/or private network capable of supporting communication among two or more of the illustrated components, or any combination thereof. In one example, the network 106 includes multiple networks, where different ones of the multiple networks are accessible to different ones of the illustrated components in FIG. 1.

The property merchant 102 can include any entity that advertises or lists properties, and/or offers the properties for sale, lease, or rent, where consumers (each indicated at 108 in FIG. 1) are not physically present at the property merchant 102 when viewing the properties. Examples of property merchants may include a variety of entities, such as, for example, Craigslist®, Zillow®, VRBO®, AirBNB®, Trulia®, Amazon®, eBay®, etc. that advertise/list properties on one or more websites by presenting images of the properties. Examples of properties include, without limitation, real property such as real estate, houses, apartments, hotel rooms, condominiums, etc. and personal property such as automobiles, other products, etc., where the properties are offered for sale, lease, or rent. In addition, while the property merchant 102 is illustrated as a single entity in FIG. 1, it should be appreciated that in the system 100 the property merchant 102 may represent multiple such property merchants.

Generally in the system 100, the property merchant 102 advertises/lists properties, and in some cases also offers the properties for sale, lease, or rent, through various websites using images of the properties displayed via interfaces at a computing device (e.g., computing device 200, etc.). The consumers 108 can then view the properties, and transact for them as desired, without actually being present at the property merchant 102. As an example, the property merchant 102 may include a listing agent, and may list multiple different apartments for rent within a city, region, or area through a website. In this example, various images of the different rooms of the apartments, and any amenities associated therewith, may be included in different webpages at the listing agent's website, such as, for example, www.vrbo.com. The images may reflect, for example, the layout, design, size, decor, condition, etc. of the apartments, so that the consumer 108 may review the apartments without ever actually visiting them.

Also in the system 100, to help ensure that the consumers 108 are viewing accurate images of the properties at the property merchant 102, the listing service provider 104 verifies the images of the properties, either before the images are permitted to be advertised/listed at the property merchant 102, or at another time prior to the consumers 108 transacting for the properties. As will be described more in connection with method 300, such verification is based on a comparison of the images of the properties to other known images of similar properties collected and stored by the listing service provider 104 in a listing database 110. This comparison can determine if the images are unique to the properties offered by the merchant 102, or are consistent with images of different properties offered by the same or other merchants. In the above example, where the property merchant 102 includes the listing agent, the listing service provider 104 verifies the images of the apartments to help ensure that they are what they purport to be, i.e., images of the actual apartments for rent, and not merely images the people listing the apartments have found in the Internet (and reflecting some other apartment). In so doing, the listing service provider 104 helps assure the consumers 108 that the images of the apartments have been verified and are reliable. With that said, it should be appreciated that verification of the images can be accomplished by the listing service provider 104, often at the request of the property merchant 102 and/or the consumers 108. For example, a property merchant 102 may require, prior to listing a property, that all images associated with the property be verified by the listing service provider 104.

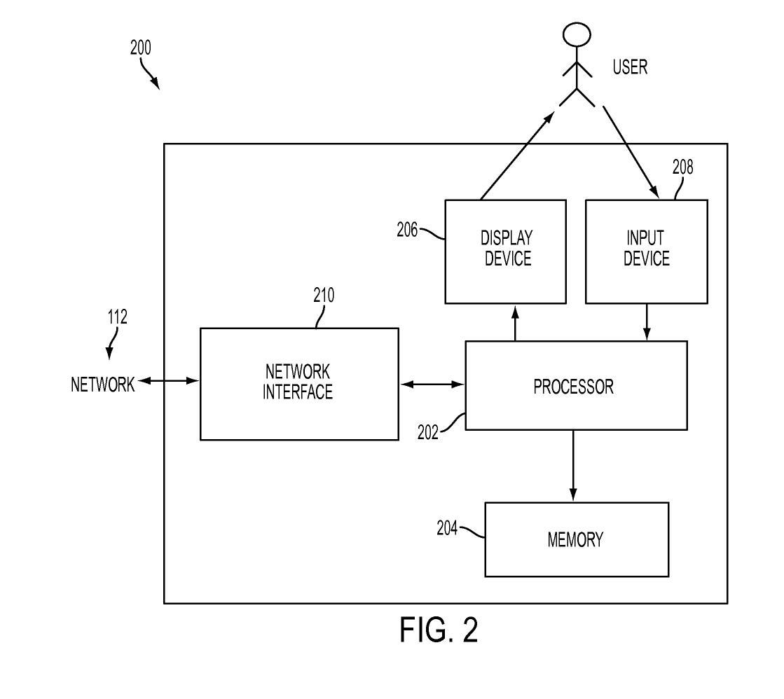

FIG. 2 illustrates an exemplary computing device 200. In the exemplary embodiment of FIG. 1, each of the property merchant 102, the listing service provider 104, and the consumers 108 are illustrated as including or being associated with computing device 200. The computing device 200 may include, for example, one or more servers, personal computers, laptops, tablets, PDAs, smartphones, etc. as appropriate.

The system 100, and its components, however, should not be considered to be limited to the computing device 200, as described below, as different computing devices and/or arrangements of computing devices may be used. In addition, different components and/or arrangements of components may be used in other computing devices. Further, in various exemplary embodiments the computing device 200 may include multiple computing devices located in close proximity, or distributed over a geographic region. Additionally, each computing device 200 may be coupled to a network (e.g., the Internet, an intranet, a private or public LAN, WAN, mobile network, telecommunication networks, combinations thereof, or other suitable network, etc.) that is either part of the network 106 (e.g., capable of supporting communication between the computing device 200 and the network 106, etc.), or separate therefrom.

The exemplary computing device 200 includes a processor 202 and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, flash drives, hard disks, and/or any other type of volatile or nonvolatile physical or tangible computer-readable media. The memory 204 may be configured to store, without limitation, listings of properties, databases of images of properties, signatures/fingerprints for the images, and/or other types of data suitable for use as described herein, etc. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

In the exemplary embodiment, the computing device 200 includes a display device 206 that is coupled to the processor 202. The display device 206 outputs to a user by, for example, displaying and/or otherwise outputting information such as, but not limited to, listings of properties, images of properties and/or any other type of data. The user may include any one or more of the consumers 108, individuals (e.g., employees, etc.) associated with the property merchant 102, individuals associated with the listing service provider 104, any other relevant individuals or entities, etc. It should be further appreciated that various pages (e.g., webpages, etc.) may be displayed at computing device 200, and in particular at display device 206, to display such images, etc. And in some cases, the computing device 200 may cause the pages to be displayed at the display device 206 of another computing device, including, for example, a server hosting a website having multiple webpages, etc. Display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices.

The computing device 200 also includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both display device 206 and input device 208.

In addition, the illustrated computing device 200 also includes a network interface 210 coupled to the processor 202 and the memory 204. The network interface 210 may include, without limitation, a wired network adapter, a wireless network adapter, a mobile telecommunications adapter, or other device capable of communicating to one or more different networks, including the network 106. In some exemplary embodiments, the computing device 200 includes the processor 202 and one or more network interfaces incorporated into or with the processor 202.

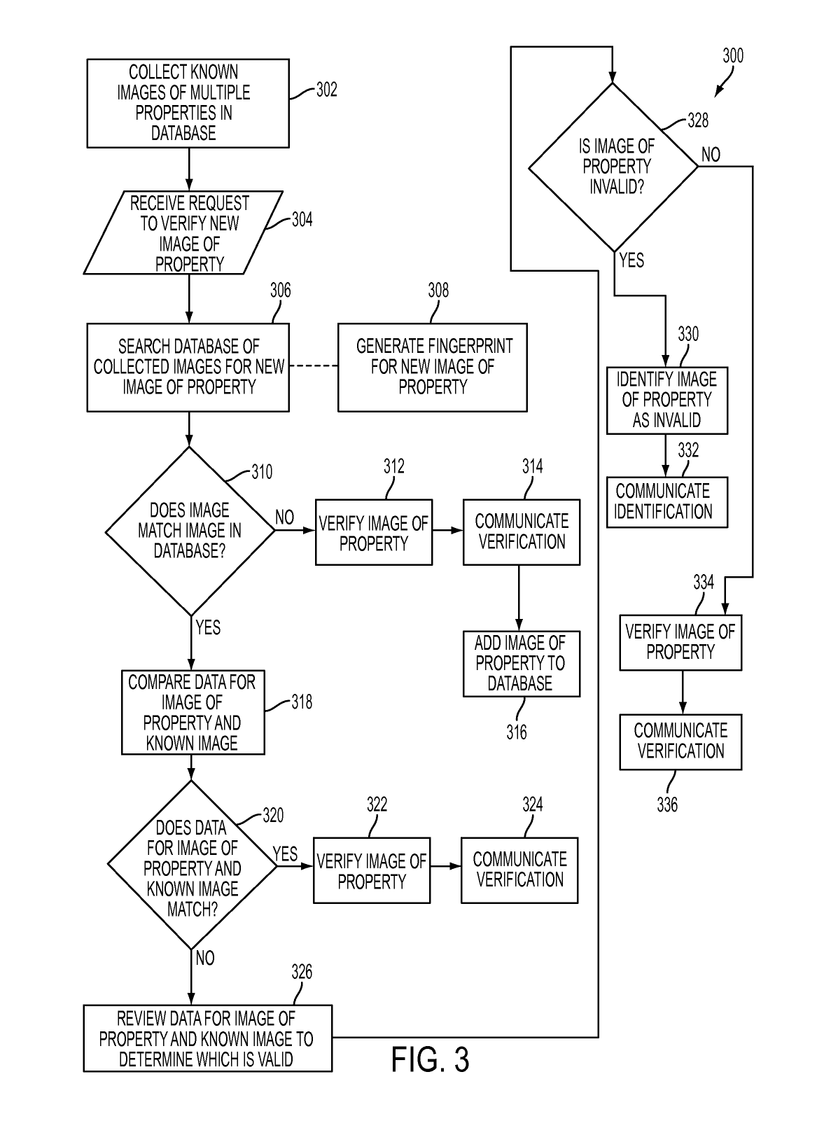

FIG. 3 illustrates an exemplary method at 300 for verifying images associated with properties offered by the property merchant 102 (e.g., via webpages included in the property merchant website displayed at one or more computing devices 200, etc.). The exemplary method 300 is described as implemented in the listing service provider 104 of the system 100, with further reference to the property merchant 102 and the consumers 108. In at least some embodiments, the listing service provider 104 may be included with the property merchant 102. In other embodiments, the listing service provider 104 may be associated with other entities, shown or not shown in FIG. 1, such as payment service providers, or other entities involved in transactions for properties shown in the images to be verified.

Further, for purposes of illustration, the exemplary method 300 is described herein with reference to the computing device 200. And, just as the methods herein should not be understood to be limited to the exemplary system 100, or the exemplary computing device 200, the systems and the computing devices herein should not be understood to be limited to the exemplary method 300.

As shown in FIG. 3, the listing service provider 104 initially collects known images (e.g., photos, etc.), at computing device 200, for multiple different properties at 302. The known images may include images of exterior features, interior features, mechanical features, etc. or any other images showing various details of the properties. The known images are stored electronically in the listing database 110 associated with the computing device 200. Further, the known images may include, without limitation, images received directly from owners of the properties (e.g., trusted sources, etc.), verified images of the properties (e.g., images verified via method 300, etc.), other images of the properties, or combinations thereof. The known images are indexed in the listing database 110, by the computing device 200 (e.g., by the processor 202 of the computing device 200, etc.), to help categorize the images and allow for subsequent identification (e.g., retrieval, etc.) and use as described below.

The indexing of the known images in the listing database 110 may be based on a variety of different information. In the exemplary embodiment of FIG. 3, for example, an electronic fingerprint is generated for each image, and the index is then generated based on the fingerprint. The fingerprint provides a unique identification to the image, so that the image can be distinguished from other images in the listing database 110. The fingerprint also provides, in this exemplary embodiment, a standardized basis of comparing the image to other images, when corresponding fingerprints are generated for the other images. For example, the fingerprint may include a numerical value generated based on the content of the image, through one or more algorithms or methods, where the numerical value is representative of and generated from the image and then used to identify the image and provide a basis for comparing the image to other images. Here, the numerical value may be generated as, for example, a MD5 hash of the image, a SHA-1 hash of the image, or any other value representative of the image and/or part thereof. The fingerprint of the image can then be compared to fingerprints similarly generated for other images to determine whether or not the images match (or substantially match), as indicated by matching (or substantially matching) fingerprints. In at least one embodiment, the images are also (or alternatively) each dissected into identifiable shapes and/or features and/or distinctive points within the images, which are then numerically represented by the fingerprints. The distinctiveness of the fingerprints may vary depending, for example, on the type of properties offered for sale, lease, or rent, the prices of the properties, etc.

It should be appreciated that any suitable algorithm or method may be employed to generate the fingerprints for the images (or sections of the images), which are substantially unique to the image. For example, and as described above, a MD5 hash may be used, a SHA-1 hash may be used, etc. Further, other exemplary processes/models that may be used to generate fingerprints of images for purposes of matching images include, without limitation, bag-of-words (converts scale-invariant feature transformation (SIFT) features into visual words via vector quantization, and then applies text retrieval techniques (e.g., inverted index and term frequency-inverse document frequency (TF-IDF) ranking, etc.)), phashion for Ruby (calculates perceptual hash of images (e.g., fingerprints), stores the hash into 64-bit integers, and calculates a “hamming distance” between two hashes/images which is the number of bits that differ between the two hashes), Lucene Image Retrieval (LIRE) (retrieves images and photos based on color and texture characteristics), imgSeek, TOP-SURF image descriptor (interest point and keypoint recognition), query-adaptive hashing (where a set of semantic-biased discriminant projection matrices are first learnt for each of the semantic concepts, through which a semantic-adaptable hash function set is learnt via a joint sparsity variable selection model), content-based image retrieval (e.g., via Picalike, Google® Image Search, etc.)), etc. Algorithms that could be used include, without limitation, the Structural Similarity Image Metric (SSIM) (considers image degradation as perceived change in structural information; SSIM is generally calculated on various windows of an image, and then the measure between two windows x and y are calculated), Peak Signal-to-Noise Ratio (PNSR), Root-Mean-Square Deviation (RMSD), etc.

In some aspects, the listing database 110 may also include descriptive data associated with each of the images, including, for example, merchant data such as merchant name, owner information, location, etc., and property data such as property category/type, property description (e.g., living room, master bedroom, pool, garden, interior, etc.), serial number, address, other unique identification information, etc. In some embodiments, keywords are generated for each of the images based on the descriptive data, and the images are then indexed based, at least in part, on the keywords.

With continued reference to FIG. 3, to verify a new image of a property (and ensure that it is not being used to fraudulently represent the property), a request is submitted to and received by the listing service provider 104, at 304, via the network 106. The request includes at least one image of the property, either directly in the request or included via a link to where the image is located on a website. The image includes a view depicting at least a portion of the property. The request may also include a request to list/advertise the property with the property merchant 102 (e.g., on the property merchant website, etc.). The property may include a current or existing property listed by the property merchant 102 (with the image being a new image of the property), or a property to be newly listed. In the illustrated method 300, the verification request originates from the property merchant 102 to verify the image, which is to be displayed through its website as part of an offering of the property to the consumers 108. However, the verification request could alternatively originate from the consumers 108 (where the consumers 108 may be interested in purchasing the property represented by the image on the property merchant website). In other embodiments, verification requests may originate from another entity, which may be associated with the property merchant 102 and/or the consumer 108, or not.

Once the verification request is received by the listing service provider 104 (at the computing device 200), the listing service provider 104 searches in the listing database 110, at 306, for the image included in the request. In the illustrated embodiment, a fingerprint is generated for the image of the property, by the computing device 200, at 308. The fingerprint is generated in the same manner previously described by which the fingerprints for the images in the listing database 110 are generated, such as, for example, by the MD5 hash, the SHA-1 hash, etc. As such, the image can be compared to the images in the listing database 110, via the uniformly generated (and standardized) fingerprints. The method 300 thereby provides a manner of comparing the image of the property in the request to the images in the listing database 110. And, after generating the fingerprint, the listing service provider 104, and more specifically, the processor 202 of the listing service provider computing device 200, searches in the listing database 110 for the fingerprint to determine, at 310, if the fingerprint of the image matches (or substantially matches) the fingerprint of another image in the listing database 110 (i.e., to determine if the image is preexisting and, for example, has been previously used to represent other properties, etc., thereby suggesting an invalid (or fraudulent) use of the image in connection with the current request). More generally, the fingerprint of the image from the request is compared to the fingerprints of the images in the listing database 110 to determine if a match exits.

For certain algorithms and methods used to generate the fingerprints of the images being compared, such as, for example, the MD5 hash, the fingerprint of the image from the request must be exactly the same as the fingerprint of an image in the listing database 110 for a match to exist (e.g., to avoid false-positive matches, particularly where the properties are similar, etc.). However, for other algorithms and methods that may be used, the fingerprint of the image from the request may only need to be within a predefined threshold of the fingerprint of an image in the listing database 110 for a match to exist (while still avoiding false-positive matches). Here, the match may include an exact match or a substantial match.

In another embodiment, the listing service provider 104 searches in the listing database 110, via the processor 202 of the listing service provider computing device 200, for keywords associated with the images stored therein (where the images are indexed in the database 110, at least in part, by the keywords). In such embodiments, the listing service provider 106 reduces the number of images, for which a comparison is to be done, by the keyword searching. As an example, the image of the property may be an image of an apartment for rent, and the image data may include a “real estate” category and a name and address of an owner of the apartment. The keyword search may then be based on the collected images in the “real estate” category in the listing database 110, to limit the images searched to real estate images, and the name and address of the owner to determine if the same or similar images are in the database 110. For multiple images returned by the keyword search, the listing service provider 106 may then further compare each to the image included in the request. The further comparison may be done, as described above, by use of a fingerprint for the images, or in other manners. In one example, the images may be converted to gray-scale, and then the pixel values for the images, either for a section or for the whole, are compared to determine if there is a match (or substantial match based on acceptable thresholds) between the images. In other examples, a color-based and/or texture comparisons between the images identified in the keyword search may be done, as compared to the image included in the request.

With further reference to FIG. 3, if the image of the property does not match any of the images in the database 110, at 310, the image of the property is considered valid, and is verified, at 312. And, a notification is sent via the network 106 to the property merchant 102, at 314 (e.g., via email, text message, mail, etc.), indicating that the image of the property has been verified. In some aspects, upon receiving the notification that the image has been verified, the property merchant 102 may then identify the image of the property as verified at the property merchant 102 computing device 200 (e.g., via an indicator on the image, via an indicator on an interface including the image, etc.), so that the consumers 108 are aware that a confirmation of the displayed image has been performed. An additional notification that the image of the property has been verified may also be sent to the owner of the image and/or property (if the owner is different from the property merchant 102). In addition, as part of verifying the image of the property at 312, the image is also added or appended to the listing database 110 of known images (along with the fingerprint generated therefor at 308) by the listing service provider 104 computing device 200, at 316, for use in subsequent verification operations.

However, if the image of the property matches (or substantially matches) one of the collected images in the database 110, at 310, the image is flagged by the computing device 200 as a preexisting image, and the matching images are then further analyzed by the computing device 200, at 318, to determine which of the matching images is/are valid. The flag for the image, as well as the image, may be stored in memory 204 of the computing device 200, or otherwise stored, in one or more embodiments. In the illustrated method, this analysis includes, via the processor 202 of the computing device 200, comparing descriptive data for the property image to the matching image from the listing database 110. If the descriptive data for the images is the same, at 320 (e.g., the images were both submitted by the same merchant, are associated with the same address, etc.), the image of the property is verified by the computing device 200, at 322, and a notification is sent to the property merchant 102 communicating the verification, via the network 106, at 324. Alternatively, if the descriptive data for the images is different, the images are even further reviewed, at 326, to determine which of the images is valid and which is not valid. This review may include any suitable investigation into the validity of the images including, for example, contacting the owners of the images and/or the properties, reviewing the properties in-person to compare against the images submitted, requesting additional images of the property to determine consistency with prior submitted images, etc.

In at least one example, the further review may initially be directed toward the property merchant 102 who submitted the verification request, rather than the property merchant (or other owner) whose images are already included in the listing database 100 (e.g., which are presumed to be valid, etc.). If the property merchant 102 requesting the verification is able to provide confirmation that the images are valid for its property, the listing service provider 104 may then seek further review of the images already in the listing database 110.

Following the further review of the images at 326, if the property image is found to be invalid (and the matching collected image is found to be valid) at 328, the property image is identified as invalid by the listing service provider computing device 200 at 330. A warning notification (or message (e.g., via email, mail, phone, etc.)) is sent by the listing service provider 104 to the property merchant 102, via the network 106, at 332, indicating that the image of the property (which was originally flagged) is invalid. In some aspects, upon determining that the property image is invalid, the property merchant 102 and/or listing service provide may reject any requests to list the property with the property merchant 102. For currently listed properties, the listing service provider 104 may also remove the image from the property merchant's computing device 200 (e.g., automatically, in conjunction with the property merchant 102, etc.), and the property merchant 102 and/or listing service provide may reject any requests to list the property with the property merchant. In addition, the listing service provider 104 may also communicate a further warning notification (or event) to the owner of the image and/or property, via the network 106, and/or add the owner to a fraudulent image listing, or “black list,” in the memory 204 of the computing device 200. Alternatively, if the property image is found to be valid (and the matching collected image from the database 110 is found to be invalid) at 326, the image of the property is verified by the computing device 200, at 334, and a notification is sent to the property merchant 102 communicating the verification, via the network 106, at 336. In addition, the matching collected image is removed from the database 110 of known images by the listing service provider 104 computing device 200 and replaced with the property image for use in subsequent verification operations, etc.

As can be appreciated, the consumers 108 may purchase the properties from the property merchant 102 through various means, including use of payment devices (e.g., credit cards, debit cards, etc.). As such, in some embodiments, payment service providers (e.g., MasterCard®, etc.), payment device issuers, acquirer banks, etc. involved in networks for facilitating such payments for the properties may implement the systems and methods herein as an added level of security to help inhibit fraudulent transactions.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving at least one image associated with a real property, the at least one image depicting at least a portion of the real property, (b) searching, in a listing database, for the at least one image, where the listing database includes a plurality of known images, each known image associated with real property, and (c) flagging the at least one image as a preexisting image when the at least one image matches one of the plurality of known images in the listing database.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. In contrast, when an element is referred to as being “directly on,” “directly engaged to,” “directly connected to,” “directly associated with,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

what is claimed is:

1. A computer-implemented method for verifying one or more images associated with a real property offered for rent, lease, and/or sale, the method comprising:
receiving, at a computing device, at least one image associated with the real property, the at least one image depicting at least a portion of the real property;
searching, in a listing database, for the at least one image, the listing database including a plurality of known images, each known image associated with real property; and
flagging, at the computing device, the at least one image as a preexisting image when the at least one image matches one of the plurality of known images in the listing database.

2. The method of claim 1, wherein receiving the at least one image includes receiving a request to list the real property for sale, lease, or rent on a website associated with a listing agency, the request including that at least one image;
the method further comprising transmitting to the listing agency a warning when the at least one image is a preexisting image.

3. The method of claim 1, wherein receiving the at least one image includes receiving a request to list the real property for sale or rent on a website associated with a listing agency, the request including that at least one image;
the method further comprising rejecting the request to list the real property when the at least one image is a preexisting image.

4. The method of claim 3, further comprising removing the at least one image from the website.

5. The method of claim 1, wherein receiving the at least one image includes receiving a request from a consumer to verify the at least one image; and
the method further comprising transmitting to the consumer a warning when the at least one image is a preexisting image.

6. The method of claim 1, further comprising generating a fingerprint from the at least one image; and
wherein searching, in the listing database, for the at least one image includes searching for the fingerprint in the listing database.

7. The method of claim 1, wherein searching for the at least one image includes searching, in the listing database, for at least one keyword associated with the at least one image and comparing at least a portion of the at least one image to a corresponding portion of an image identified by the keyword search.

8. The method of claim 7, wherein comparing at least a portion of the at least one image includes comparing a fingerprint for the at least one image to a fingerprint for the image identified by the keyword search.

9. The method of claim 1, wherein the real property include one of a house, an apartment, a hotel room, and a condominium.

10. The method of claim 1, further comprising appending the at least one image to the listing database when the at least one image does not match one of the plurality of known images in the listing database.

11. The method of claim 10, wherein appending the at least one image to the listing database includes generating a fingerprint for the at least one image and storing the fingerprint in the listing database.

12. A system for verifying images associated with properties, the system comprising:
a listing database configured to store multiple known images, each of the known images associated with a property offered for sale or rent; and
a processor coupled to the listing database, and configured to:
compare an image of a property to the known images of properties in the database;
append the image of the property to the listing database when the image does not match one of the known images in the listing database; and
generate a flag for the image of the property when the image matches a known image in the listing database.

13. The system of claim 12, wherein the processor is configured to generate a fingerprint for at least a portion of the image of the property, and search in the listing database for the fingerprint, in order to compare the image to the known images in the listing database.

14. The system of claim 13, wherein the processor is configured to index the appended image by at least one of the fingerprint and a keyword associated with the image.

15. The system of claim 12, wherein the processor is configured to receive a request to list the property for sale or rent on a website associated with a listing agency, the request including the image, and to reject the request when the flag is generated for the image.

16. The system of claim 15, wherein the processor is further configured to remove from the website a listing associated with image when the flag is generated for the image.

17. The system of claim 12, wherein the processor is further configured to communicate a warning message indicating the flag generated for the image to at least one of a listing agency and a consumer.

18. The system of claim 11, wherein the property is selected from the group consisting of an apartment, a hotel room, and a vehicle.

19. A non-transitory computer readable media comprising instructions that, when executed by at least one processor, cause the at least one processor to:
receive an image associated with a property;
compare the image of the property to known images of properties in a listing database of images based on at least one of a fingerprint and a keyword associated with the image;
append the image of the property to the listing database when the image does not match one of the known images in the listing database; and
generate a flag for the image of the property when the image matches a known image in the listing database.

20. The non-transitory computer readable media of claim 19, wherein the instructions further cause the at least one processor to reject a listing request associated with the image of the property when the flag is generated for the image.
